(19) United States
(12) Patent Application Publication
(10) Pub. No.: US 2019/0285791 A1
(43) Pub. Date: Sep. 19, 2019

(54) Light-Guiding System, especially for the Lighting of Land Transport Means

(71) Applicant: Varroc Lighting Systems, s.r.o., Senov u Noveho Jicina (CZ)

(72) Inventors: Tomas Gloss, Vitkov (CZ); Ales Hendrych, Hostalkova (CZ); Jakub Hruska, Hlucin (CZ)

(21) Appl. No.: 16/353,595

(22) Filed: Mar. 14, 2019

(30) Foreign Application Priority Data
Mar. 15, 2018 (CZ) PV 2018-131

(51) Int. Cl. F21V 8/00

(52) U.S. Cl. CPC G02B 6/0008; B60Q 1/00

(57) ABSTRACT

The invention relates to a light guiding system, especially for the lighting of land transport means, which comprises a line light guide (1), one end of which is associated with a light source (3), whereby the line light guide (1) is along its length provided with a coupling out surface (13) of light, opposite which is arranged an inclined reflective wall (4) directing the light coupled out of the line light guide (1) into a radiating body (2), from which the light comes out in a desired direction (X, 10 d). The line light guide (1) is longitudinally curved and the coupling-out surface (13) of the light guide (1) is arranged in a plane parallel to the plane of the curvature of the light guide (1), whereby the inclined reflective wall (4) follows the curvature of the light guide (1) and is along its length along the line light guide (1) provided with reflective directing surfaces (4a) which are adapted to reflect the beams (10b) to the plane of the light output and at the same time to a direction (10c) which corresponds to the light emitted at the output surface (20) of the radiating body (2) to the required resulting direction (X) of the light beams (10d) along the entire length of the inclined reflective wall (4).

### TECHNICAL FIELD

The invention relates to a light guiding system, especially for the lighting of land transport means, which includes a line light guide, whose one end is associated with a light source, whereby the line light guide is along its length provided with a coupling-out surface of light, against which is arranged an inclined reflective wall directing the light coupled out of the line light guide to a radiating body, from which the light is emitted in a desired direction.

### BACKGROUND ART

The use of light guides for the lighting of land transport means as such is well-known. Light guides allow the light to be transmitted from a light source to a point of light output and to be coupled out in a desired direction, which makes it possible to realize a variety of previously infeasible design and shape solutions of the light output arrangement while maintaining the homogeneity and power of the output light beam. In light guides, the light is guided longitudinally by total internal reflection of light from the walls of the light guide and the light is coupled out directly in the desired direction by means of coupling-out optics. However, this only applies if the light source is placed in a suitable position relative to both the light guide and the direction in which the light from the light guide system is to be coupled out. The problem arises in situations when it is not possible to place the light source in the assembly of the system in a suitable position to ensure the coupling-out of the light in the desired direction by means of the coupling-out optics. Instead, a significant amount of light is reflected or refracted in a completely different direction than is required, and such a solution is accompanied by light loss and a large drop in efficiency. Moreover, if it is required that the light guide be substantially curved in a direction or, more specifically, in the plane in which the light from the light guide is to be coupled out, the negative influence of the position of the light source is even greater.

DE 10 2004 054 732 A1 discloses a solution in which a longitudinal light guide is slightly bent and is arranged along the rear wall of a radiating body. On the opposite side from the rear wall of the radiating body, the light guide is provided with a system of deflecting structures, disposed perpendicularly to the direction in which the radiation is travelling. These deflecting structures assist deflection of the light spread by the light guide to the rear wall of the radiating body and then through this body out of the light system in a substantially general direction. The disadvantage of this solution is the fact that if the light guide has a greater curvature in the direction of the light being coupled out, there is an increase in the proportion of the light transmitted by Fresnel reflections, which results in light loss which will manifest itself in the direction of the light being coupled out by a noticeable decrease in luminous intensity. This decrease can be compensated for, e.g., by using several different light sources along the length of the light guide. This, however, is not always possible for spatial and other reasons.

Such a solution with a plurality of light sources along the length of the light guide curved in the direction of the coupling out of light is disclosed, e.g., in EP 3 112 215, which describes a lighting device with a light guide curved in the direction of the light being coupled out, in which one light source is associated with a front end wall of the curved portion of the light guide and along the length of the rear curved wall of the light guide a plurality of other light sources are arranged from which light is transmitted to the light guide by optical adapters, by which the light is directed from these other light sources into the light guide substantially perpendicularly to the longitudinal axis of the light guide and through the coupling-out surface of the light guide. The disadvantages of this arrangement include, for example, its considerable complexity and, naturally, high cost, as well as the need to use a plurality of light sources and great requirements for space.

US 2015/0219818 describes a solution, which comprises a longitudinal planar radiating body, one longitudinal side of which is associated with a group of longitudinal direct light guides, i.e., light guides parallel to this longitudinal side of the radiating body. The individual light guides are provided with a light coupling-out surface on their rear wall facing the radiating body. The radiating body is provided with simple inclined and perpendicular surfaces on its longitudinal side with which the longitudinal light-guide are associated. These inclined and perpendicular surfaces provide the entrance or reflection or refraction of the light from each of the light guides into the radiating body along the length of each light guide and the length of the radiating body. Each light guide is at one of its ends associated with one light source, whereby the light sources have, e.g., a different color, e.g., the light sources include red, green, and blue (RGB) LEDs, and so the resulting light emitted by the radiating body may have, in principle, any color, or the radiating body may emit only one of the colors if the other light guides are not currently illuminated, etc. The disadvantage of this arrangement is that with the light guide curvature and the requirement for the light emitting in a pre-determined direction along the entire length of the light guide and the radiating body, in some light guides of the system/assembly a substantial portion of the light coupled out into the radiating body will be lost due to Fresnel reflections, which results in disruption of the homogeneity the light emitted by different light guides along the length of the radiating body.

The aim of the invention is to eliminate or at least reduce the drawbacks of the background art, especially to reduce significantly the extent of light loss in the light guide even in situations when the light source is placed in an ideal position and the light guide is curved considerably along its length relative to the desired direction of light radiation and, consequently, the conditions in which the light can be still evenly coupled out of the light guide in the desired direction. Furthermore, the aim of the invention is to guide the light being coupled out by the light guide by total internal reflection to a maximum extent and, at the same time, to ensure that the light being coupled out is emitted in sufficient intensity and homogeneity by the light guiding system in a desired direction or only with a slight deviation from the desired direction.

### SUMMARY OF THE INVENTION

The aim of the invention is achieved by a light guiding system, especially for the lighting of land transport means, whose principle consists in that a line light guide is longitudinally curved and a light coupling-out surface is arranged in a plane parallel to the plane of the light guide curvature, whereby an inclined reflective wall follows the light guide curvature and is along its length along the line light guide provided with reflective directing surfaces which are adapted to reflect beams to the plane of the light output and simultaneously to a direction corresponding to the change of the direction of the output light on the output surface of the radiating body to a desired resulting direction of the light beams along the entire length of the inclined reflective wall.

In addition, the invention allows to couple out light propagated by a very longitudinally curved line light guide by total internal reflection in the desired direction while maintaining sufficient intensity and homogeneity of the output light without unnecessary loss due to Fresnel reflections, especially if it is impossible to place the light source in an optimal position relative to the line light guide or when a particular shape or design arrangement of the optical system is required, for example, in the case of significant curvature of the surfaces in the system structure, etc.

### DESCRIPTION OF THE DRAWINGS

The invention is schematically illustrated in a drawing, wherein

FIG. 1 shows a view from above of the configuration of a lighting device of motor vehicles for using the light guiding system according to the invention,

FIG. 2 illustrates the basic principle of the operation of the light guiding system according to the invention,

FIG. 3 shows a three-dimensional view from below of the light guiding system according to the invention,

FIG. 4 shows a detail of the light guided by the light guiding system according to the invention,

FIG. 5 shows a detail of variability in the spatial orientation of the reflective directing surfaces relative to the coupling-out surface of the line light guide in the direction of the length of the line light guide,

FIG. 6 shows a light beam being guided and refracted by the light guiding system according to the invention and

FIG. 7 shows an exemplary embodiment with an inclined reflective wall on a separate optical element.

### DETAILED DESCRIPTION

The invention will be described with reference to exemplary embodiments of a light guiding system for motor vehicles which has a pre-determined direction X of the light radiation into the target illuminated area O in front of the light guiding system. The light guiding system is arranged in a cover 00.

The light guiding system comprises a line light guide 1, which is arranged in the X-Y plane of the Cartesian coordinate system and is curved around the Z axis. The bend of the line light guide 1 is either circular, i.e. with a constant radius, or non-circular, i.e. with a variable radius, e.g. in the shape of a suitable curve, e.g., a conic section, or the light guide 1 has a generally curved shape according to current requirements. To make use of the present invention, it is important for the bend of the line light guide 1 to be greater than the maximum bend allowing to couple out the light guided within the line light guide 1 by total internal reflection directly in the desired X direction with the required performance and tolerable light loss. This maximum bend of the line light guide 1 which enables to couple out the light directly in the X direction is related to the propagation of light within the light guide 1 with light loss and is usually described as the value of the angle between the tangent at a respective point of the line light guide 1 and a line which is perpendicular to the desired direct direction of radiation from the line light guide 1, that is, here it is the angle between the tangent at a respective point of the line light guide 1 and the Y axis, which is perpendicular to the direct direction of the radiation of the entire system, i.e. the X axis. That means that here this angle lies in the X-Y plane.

The line light guide 1 is provided along its length with a coupling-out surface 13, which is adapted to couple out the light beams from the inner space of the line light guide 1 to the direction of the Z axis and which is situated parallel to the X-Y plane of the line light guide 1, that is, in a plane parallel to the X direction of the radiation of the entire system.

The front surface 100 of the line light guide 1 is associated with a light source 3, whereby the front surface 100 of the line light guide 1 is adapted to couple the light into from the light source 3. The light is emitted from the light source 3 at specified scattering and the beams 10 of this light are coupled via the front surface 100 of the line light guide 1 into the inner structure of the line light guide 1, where they propagate by total internal reflection along the entire length of the line light guide 1, whereby in the direction 10a they fall on the coupling-out surface 13 of the line light guide 1, by which means the light, or the light beams 10, is/are gradually coupled out of the line light guide in the direction 10b, which is perpendicular to the X-Y plane of the coupling-out surface 13, preferably in the Z direction of the rectangular coordinate system, i.e. perpendicularly to the X-Y plane. As a result, the light coupled out of the line light guide 1 in the direction of the Z axis or in the direction of the beams 10b has sufficient and required homogeneity and intensity along the entire length of the line light guide 1.

An inclined reflective wall 4 is arranged opposite the coupling-out surface 13 on the opposite side of the line light guide 1, i.e. above the line light guide or below the line light guide 1. The inclined reflective wall 4, whose curvature follows the curvature of the line light guide 1, is adapted to direct the light coupled out of the line light guide 1 in the direction 10b, i.e. in the direction of the Z axis, along the entire length of the line light guide 1 to the X-Y plane, in which lies the desired X direction of the radiation of the entire system, and at the same time the inclined reflective wall 4 is adapted to direct the light in the X-Y plane to the direction of the beams 10c, which closely correlates with the resulting output direction of the light beams 10d, i.e., the desired direction X of the light output from the entire system, since the emitted light is at the output surface 20 of the whole system further refracted to the output direction 10d, which corresponds to a desired resulting direction X of the light from the entire system, since the light propagation through the entire system as far as beyond the output surface 20 is affected by the bend of the line light guide 1, by the bend of the reflective wall 4, by the bend of the front coupling-out wall 20 of the whole system, as well as by the required arrangement of the target illuminated area O of the system, by the material of the individual components, the interfaces of the individual environments, etc., as will be described in more detail below. The inclination of the inclined reflective wall 4 corresponds to the desired change of the direction of the beams 10b to the direction 10c, in an embodiment shown it is 45° relative to the X-Y plane, because the coupling-out surface 13 of the line light guide 1 is parallel to the X-Y plane of the desired direction X of the light output from the entire system.

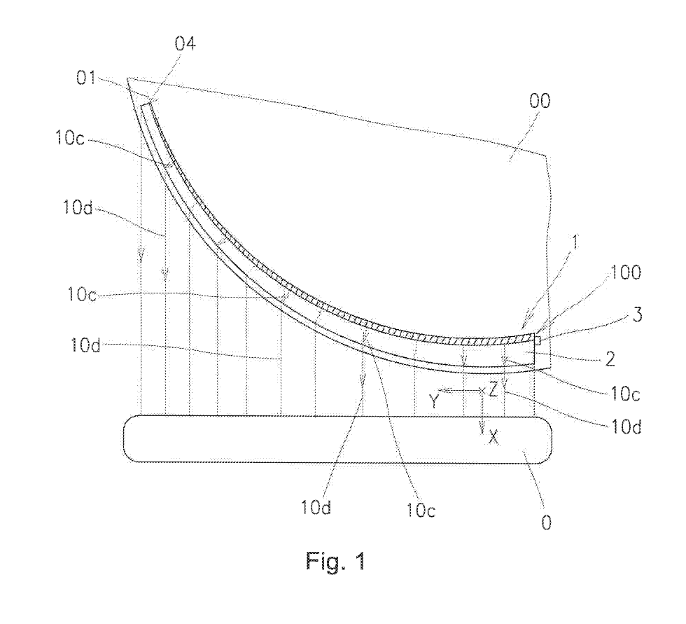

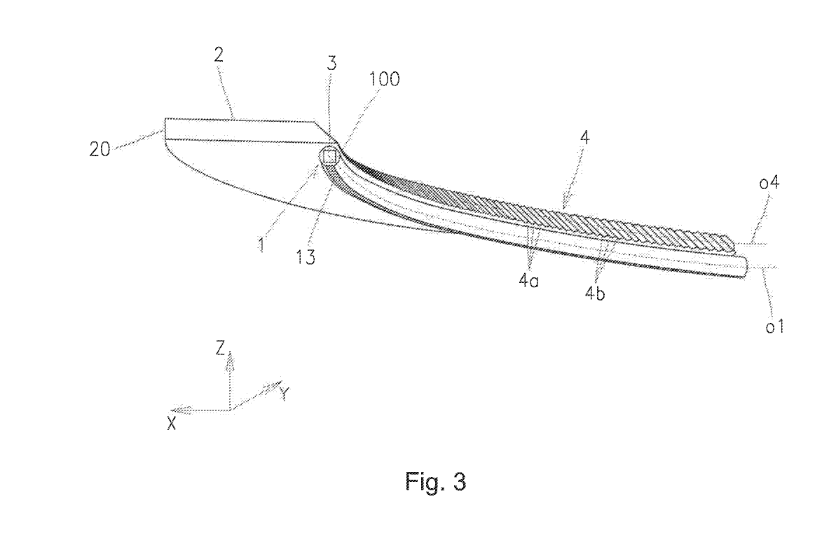

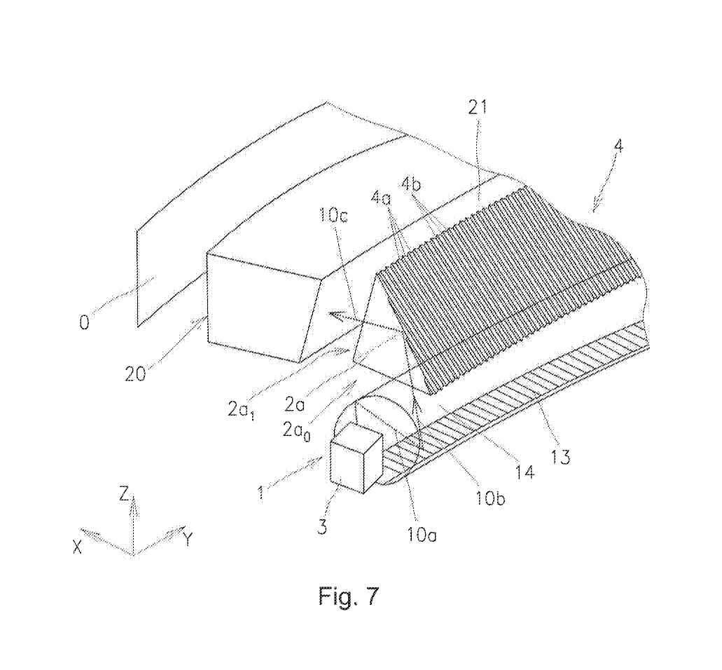

In an exemplary embodiment shown in FIGS. 1 to 4, the inclined reflective wall 4 is formed at the rear end of the flat radiating body 2 which constitutes the output element of the light guiding optical system. Preferably, the flat radiating body 2 is arranged in the plane of the light output, for simplification, the flat radiating body 2 is, for example, arranged in a plane parallel to the X-Y plane of the bend of the line light guide 1 and also in a plane parallel to the coupling-out surface 13 of the line light guide 1. The radiating body 2 is on its front side provided with an output surface 20, through which the light is emitted in the desired X direction and in the target illuminated area O. The output surface 20 is also bent around the Z axis, similarly to the bend of line light guide 1. In an example of embodiment in FIG. 7, the inclined reflective wall 4 is formed on a separate optical element 2a, which is inserted between the coupling-out surface 13 of the line light guide 1 and the rear wall of the radiating body 2. The separate optical element 2a with its surface 2a0 opposed the light guide 1 follows the bend of the light guide 1 and at the same time with its surface 2a1 opposed the rear wall 21 of the radiating body 2 copies the rear wall of the radiating body 2. In an unillustrated embodiment, the separate reflective element 2a and/or the radiating body 2 has/have sufficiently small dimensions, which allows significant savings of the built-in space within the lighting device while maintaining the advantages of the invention. This is achieved, for example, by a modification of the embodiment of FIG. 7, in which the separate reflective element 2a would directly constitute the output member of the whole system and the surface 2a1 would constitute the light output surface 20 of the whole system. Thus, as opposed to the embodiment of FIG. 7, the radiating body 2 shown in FIG. 7 would not be used.

In order to guide the beams 10b coupled out of the line light guide 1 by means of the inclined reflective wall 4 to the direction of the light beams 10c and subsequently to the required resulting direction X of the beams 10d, i.e. not only to direct the beams 10b from the direction in the Z axis do the X-Y plane, but also to direct these beams the X-Y plane directly to the direction of the beams 10c, and subsequently via the output surface 20 to the resulting X direction of the beams 10d, the inclined reflective wall 4 along its length is provided with a row of reflective directing surfaces 4a, arranged next to each other, which are adapted to reflect the beams 10b coupled out of the line light guide 1 along the length of the line light guide to the direction of the beams 10c in the radiating body 2, whereby the beams 10c on the output surface 20 of the radiating body 2 change their direction (through the refraction on the output surface 20 due to the change of environment and due to the bend of the output surface 20 around the Z axis) to the direction of the beams 10d, which is the desired X direction of the light output from the system, as shown in FIGS. 1, 4 and 6.

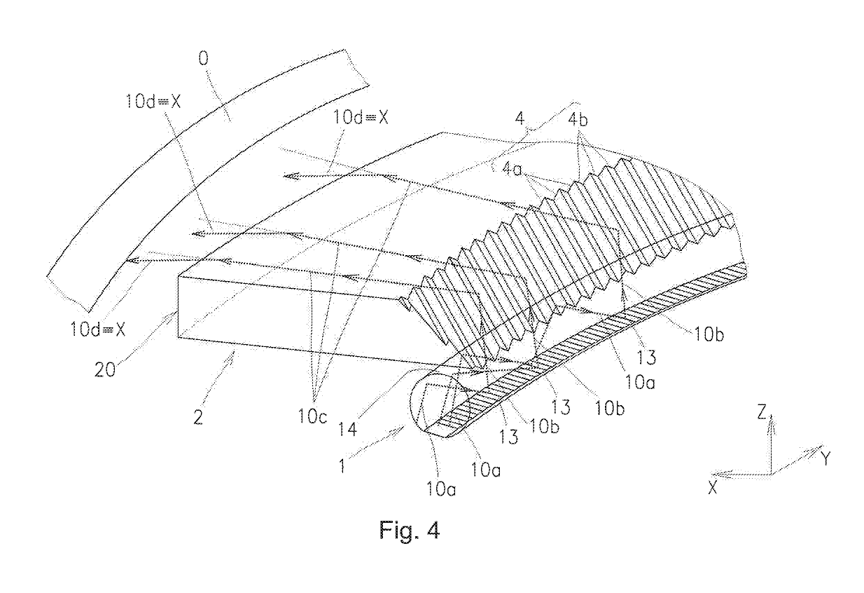

Along the length of the inclined reflective wall 4, the individual reflective directing surfaces 4a are turned by different angles with respect to the Y axis, which is dependent on the distance of the respective reflective directing surface 4a from the light source 3, and is further dependent on the bend of the line light guide 1, on the bend of the inclined reflective wall 4, on the bend of the output surface 20 of the radiating body 2, etc., so that the overall result will be the light output from the output surface 20 of the radiating body 2 in the desired direction X to the target illuminated area O. Because of the manufacturability, the adjacent reflective directing surfaces 4a are separated by inactive surfaces 4b, as shown, for example, in FIG. 4.

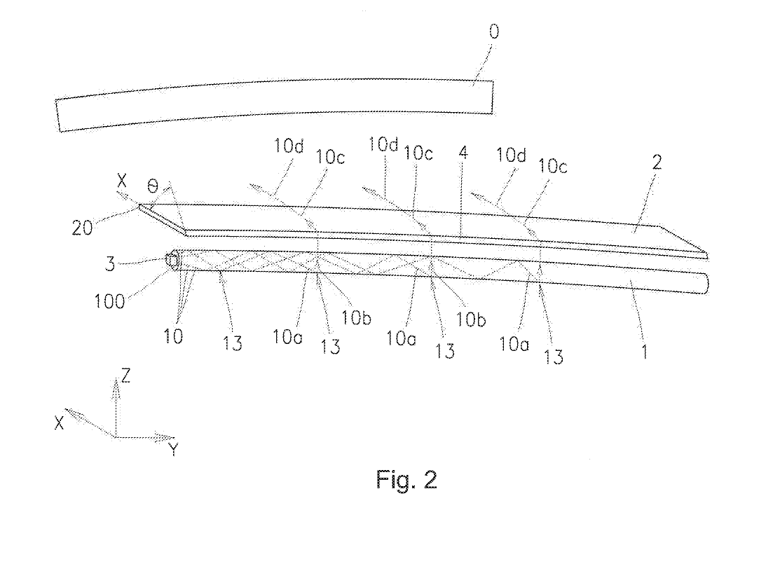

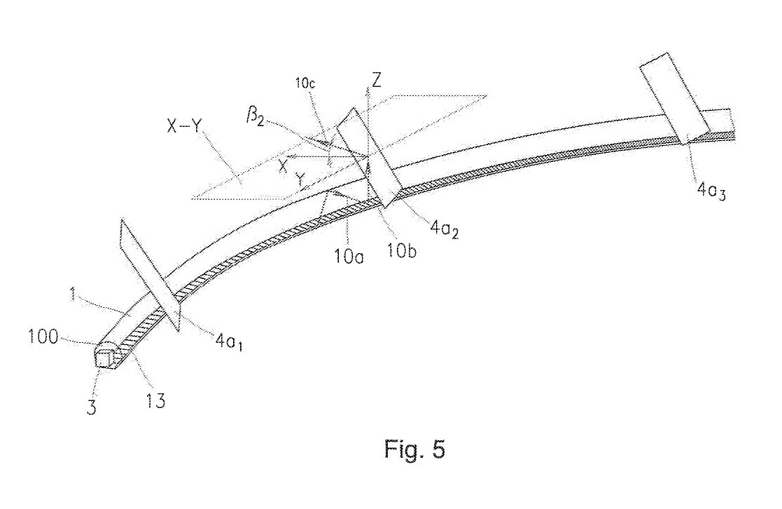

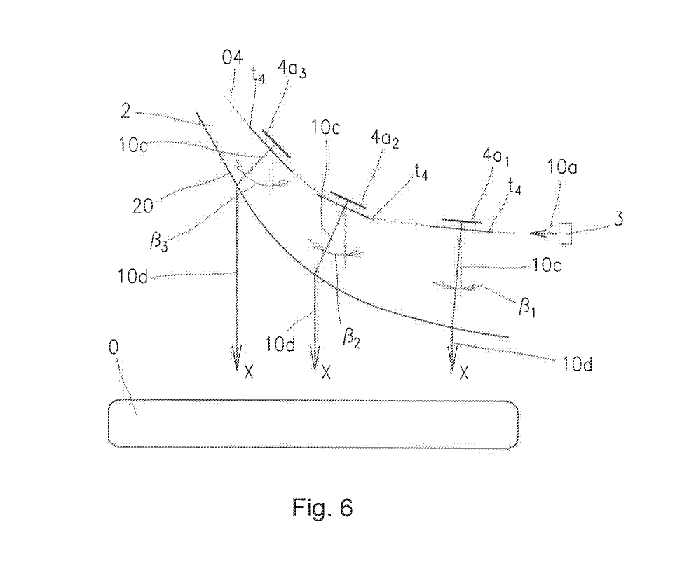

FIG. 5 shows reference directions of three different reflective directing surfaces 4a₁, 4a₂, 4a₃ arranged along the length of the inclined reflective wall 4, or, in other words, along the length of the line light guide 1, whereby the inclination of the inclined reflective wall 4 relative to the X-Y plane is indicated by the angle θ in FIG. 2. The desired direction of the beams 10c reflected by means of the reflective directing surfaces 4a₁, 4a₂, 4a₃ from the direction of the beams 10b coupled out from the respective portion of the line light guide 1 is determined by the reflecting angles β₁, β₂, β₃, in which the light from each respective reflective directing surface 4a₁, 4a₂, 4a₃ must arrive at the output surface 20, so that it can be further “directed” by refraction to the desired output direction X of the beams 10d, as shown in FIG. 6 and as follows from the dashed lines indicating the beams 10c and 10d in FIG. 1. The reflective directing surfaces 4a, by which the light is reflected from direction 10b to desired direction 10c, are arranged correspondingly relative to the curvature of the inclined reflective wall 4 (as indicated in FIG. 6 by the O4 axis of the curvature of the inclined reflective wall 4) at a specific point along the length of the inclined reflective wall 4, or, in other words, along the length of the line light guide 1. Since the curvature of the inclined reflective wall 4 follows the curvature of the line light guide 1, this orientation of the reflective directing surfaces 4a is used also in relation to the O1 axis of the curvature of the line light guide 1 as well as relative to the coupling-out surface 13 of the line light guide 1.

As is apparent from the above-mentioned facts, each of the reflective directing surfaces 4a changes the direction of the reflection of the light beams 10b coupled out of the line light guide 1 from the direction of the beams 10b to the desired direction of the beams 10c, as shown also in FIGS. 2, 4, 5 and 7. The light thus directed then passes through the body 2 emitting the beams 10c, from which it exits via the output surface 20 in the desired final output direction X of the beams 10d, either directly without further direction change, or by using light refraction at a suitably curved output surface 20 of the radiating body 2 in the X-Y plane, i.e. using light refraction at the boundary between two environments, for example, the radiating body 2—air.

In the simplest example of embodiment, the reflective directing surfaces 4a are formed by a row of narrow planar reflective surfaces mutually separated by inactive surfaces 4b, whereby the light passing through the optical system is not affected by the inactive surfaces or is affected by them only to a small (acceptable) extent. As follows from the above-mentioned facts, the reflective directing surfaces 4a are inclined relative to the X-Y plane to reflect the light to the desired plane of the light output, here the X-Y plane, and at the same time are turned by reflecting angle β, in an embodiment shown β₁, β₂, β₃ relative to the O4 axis of the curvature of the reflective surface 4, or relative to the O1 axis of the curvature of the line light guide 1. It is clear that the magnitude of the reflecting angle β changes along the length of the inclined reflective wall 4 and hence along the length of the line light guide 1 and corresponds to the desired directions of the beams 10c and 10d in relation to the desired position and size of the target illuminated area O produced by the system according to the invention, of the curvature of the individual elements of the system, etc.

As follows from the above-mentioned facts, the system operates in such a manner that the light from the light source 3 is coupled into the curved line light guide 1, through which it propagates in the form of beams 10a along the entire length of the light guide 1. At the same time, a portion of the light along the entire length of the line light guide 1 falls on the coupling-out surface 13 of the line light guide 1, through which this light is coupled out in the Z direction (in the form of the beams 10b) from the line light guide 1, whereupon the light being coupled out in this manner from the line light guide 1 falls on the individual reflective directing surfaces 4a arranged along the length of the curved and inclined reflective wall 4 disposed opposite the coupling-out surface 13 of the line light guide 1. The individual reflective directing surfaces 4a along the entire length of the inclined reflective wall 4 and hence along the entire length of the line light guide 1 reflect the light to the direction of the plane of the light output, here the X-Y plane, and at this output surface the reflected light is directed by the individual reflective directing surfaces 4a to the direction of the beams 10c, which, in conjunction with possible further adjustment of the direction of light to the direction of the beams 10d, e.g., with the subsequent refraction of light at a suitably curved output surface 20 of the radiating body 2, corresponds to the desired resulting X direction of the light to the target illuminated area O. It is clear that the mutual synergy of the spatial orientation of the reflective directing surfaces 4a along the length of the inclined reflective wall 4 and hence along the length of the line light guide 1 and possible adjustment of the direction of light (e.g. by using refraction) at the output surface 20 of the radiating body 2 along the length of the output surface 20 of the radiating body 2 determine the resulting direction X of the light from the system and also determine the position and size of the target illuminated area O produced by the system according to the invention.

### INDUSTRIAL APPLICABILITY

The invention is usable in designing and manufacturing lighting devices, especially for land vehicles.

1-7. (canceled)

8. A light guiding system comprising:
a light source for emitting light;
a line light guide having an end associated with the light source for receiving the light from the light source, the line light guide having a length and a coupling-out surface along the length for coupling-out of the line light guide light received from the light source, the line light guide being longitudinally curved and defining a curvature in a plane of curvature, the coupling-out surface being arranged in a plane parallel to the plane of the curvature;
a radiating body having an output surface and defining a light output plane; and
an inclined reflective wall located along the line light guide opposing the coupling-out surface for directing the light coupled out of the line light guide through the radiating body and out of the output surface in a desired direction, the inclined reflective wall configured to extend along and follow the curvature of the line light guide, the inclined reflective wall including reflective directing surfaces configured to reflect the light coupled out of the light guide along the light output plane and in a direction within the light output plane along the radiating body relative to the output surface so that the light emitted at the output surface is in the desired direction.

9. The light guiding system according to claim 8, wherein a magnitude of a respective angle of rotation of each one of the reflective directing surfaces relative to a tangent to a curvature of the inclined reflective wall at a location of the one of the reflective directing surfaces varies along a length of the inclined reflective wall.

10. The light guiding system according to claim 8, wherein a magnitude of a respective angle of rotation of each one of the reflective directing surfaces relative to a tangent to a curvature of the inclined reflective wall at a location of the one of the reflective directing surfaces is determined in view of a curvature of the output surface and a material of the radiating body.

11. The light guiding system according to claim 8, wherein the reflective directing surfaces are configured as planar reflective surfaces and are separated from each other by inactive surfaces.

12. The light guiding system according to claim 8, wherein the inclined reflective wall is part of the radiating body.

13. The light guiding system according to claim 8, wherein the inclined reflective wall is provided on a separate optical element from the radiating body, the separate optical element having a surface opposite the line light guide following the curvature of the line light guide and a surface opposite a rear wall of the radiating body following the rear wall of the radiating body.

14. The light guiding system according to claim 8, wherein a curvature of the inclined reflective wall is dependent upon a curvature of the output surface.
